(19) United States
(12) Patent Application Publication
(10) Pub. No.: US 2021/0308620 A1
(43) Pub. Date: Oct. 7, 2021

(54) Carbon, nitrogen and oxygen separator and method of use thereof

(71) Applicant: Viva Cundliffe, Kamloops (CA)

(72) Inventor: Viva Cundliffe, Kamloops (CA)

(21) Appl. No.: 13/261,291

(22) PCT Filed: Oct. 29, 2009
(86) PCT No.: PCT/CA2009/001540

§ 371 Date: Jul. 9, 2012

(51) Int. Cl. B01D 53/22; B01D 57/02; B01D 63/06; B82Y 40/00; C01B 13/02; C01B 21/02; C01B 32/15; C01B 32/205; C01B 32/26

(52) U.S. Cl. CPC B01D 53/22; C01B 2210/0098; B01D 63/06; B82Y 40/00; C01B 13/0251; C01B 21/02; C01B 32/15; C01B 32/205; C01B 32/26; B01D 2313/22; B01D 2313/24; B01D 2313/345; B01D 2313/365; B01D 2257/102; B01D 2257/104; C01B 2210/0046; C01B 2210/0045; B01D 57/02

(57) ABSTRACT

An apparatus and a method for producing carbon, oxygen and optionally nitrogen from treated flue gases are provided. The apparatus provides a thermo-dielectric-electric field that splits molecules of carbon dioxide and carbon monoxide into carbon and oxygen and nitrogen oxides into nitrogen and oxygen. The carbon is recovered in a variety of solid forms, and oxygen and nitrogen are recovered as gases.

### FIELD

The present technology is directed to the use of thermo-dielectric-electro-dynamics (TDEED) to separate carbon and oxygen ions. More specifically, the technology relates to an apparatus and method for collection of oxygen and solid carbon from carbon dioxide and carbon monoxide using a thermo-electric field.

### BACKGROUND

Most carbon dioxide and carbon monoxide technologies use catalysts to effect the separation of carbon from oxygen. For example, US Patent Publication No. 20070149392 discloses a multifunctional catalyst system comprising a substrate; and a catalyst pair disposed upon the substrate; wherein the catalyst pair comprises a first catalyst and a second catalyst; and wherein the first catalyst initiates or facilitates the reduction of carbon dioxide to carbon monoxide while the second catalyst initiates or facilitates the conversion of carbon monoxide to an organic compound. A method is also disclosed comprising reducing carbon dioxide to carbon monoxide in a first reaction catalyzed by a first catalyst; and reacting carbon monoxide with hydrogen in a second reaction catalyzed by second catalyst; wherein the first catalyst and the second catalyst are disposed upon a single substrate.

Canadian Patent Application 2507946 disclosed a controlled flow CO2/CO gas thermal reformation device, heated by a flow of inert gas or liquid metal, through secondary tubing, or by high heat elements, for the production of oxygen and carbon. The oxygen is collected by means of an oxygen selective membrane system, while carbon is collected on carbon attracting materials in a trapping area, or is collected on an electric, magnetic or para magnetically charged device or a scraping device. The thermal reformation device may be pressurized.

Both Itoh et al (Application of membrane reactor system to thermal decomposition of CO2, Journal of Membrane Science, 77, 245-253) and Nigara and Cales (Production of CO by direct thermal splitting of CO2 at high temperature, Bulletin of the Chemical Society of Japan, 59, 1997-2002) disclose thermal dissociation of carbon dioxide using oxygen permeable zirconia membranes at high temperatures for the production of carbon monoxide and oxygen. Neither teach nor contemplate splitting of carbon dioxide into oxygen and carbon.

US Patent Publication No. 20060213782 discloses an apparatus is provided for dissociating carbon and oxygen from carbon dioxide molecules. The apparatus includes a thin plate made of a solid permeable ion-conducting membrane having a partial coating of platinum on a first side and ruthenium oxide on a second. The membrane is preferably a zirconium oxide, and includes yttrium oxide. An electric potential is applied between two surfaces of the membrane and the membrane is heated by a heating element. Carbon dioxide gas is brought into contact only with the negatively charged first side of the membrane. The oxygen atoms are put under an electric field, separate from the carbon atoms and enter the membrane, and become oxygen ions. The ions are transported across the membrane to the positively charged side, where they lose their negative charge and exit the membrane as pure oxygen. The carbon does not pass through the membrane and is left behind. The carbon is detached from the membrane and collected as powder for use or disposal.

Ito et al (Carbon and copper nanostructured materials syntheses by plasma discharge in a supercritical fluid environment, Journal of Materials Chemistry, 14, 1513-1515) disclosed the use of a nickel cathode-nickel anode electrode as a means of generating pulsed discharges that resulted in the production of carbon from carbon dioxide. In a later study, Tomai et al (Carbon materials syntheses using dielectric barrier discharge microplasma in supercritical carbon dioxide environments, Journal of Supercritical Fluids, 41, 404-411) used a dielectric barrier discharge microplasma in supercritical carbon dioxide to produce amorphous carbon, graphite and nano-carbon. The temperatures for carbon production ranged from 30 C to 80 C and the pressure ranged up to 8 to 12 MPa. Production rates were low and not suitable for carbon capture at a commercial level.

### SUMMARY

A separator for carbon, oxygen and nitrogen is provided that permits industrial scale splitting of one or more of carbon dioxide and carbon monoxide into solid carbon and gaseous oxygen, and optionally nitrogen oxides into gaseous nitrogen and oxygen. The separator comprises:

(i) a chamber having a working zone, a transition zone, and a carbon collection zone, wherein at least one dielectric structure, at least one oxygen permeable membrane and at least one heat source are located in the working zone and wherein at least one carbon collection system is located in the carbon collection zone;

(ii) a treatment gas inlet located in the vicinity of the top of the chamber to provide treatment gas to the working zone;

(iii) a pressure maintainer in communication with the chamber;

(iv) an oxygen outlet in gaseous communication with the oxygen permeable membrane;

(v) an optional cooling source located in the vicinity of the bottom of the chamber to provide cooling to the carbon collection zone; and

(vi) a valve or access port located in the vicinity of the bottom of the chamber for removal of solid carbon from the carbon collection zone.

As it is more cost-effective, the dielectric structure and the heat source are preferably integrated into a single component that provides dielectric and electrophoretic capability and thermal energy. An electrical heating element can provide both the electrical and thermal functions.

As the operating temperatures and amperages in the working zone of the chamber are high, the heating element is selected to provide temperatures ranging from about 1000 C to about 2400 C and amperages ranging from about 10 amps to about 150 amps.

It is preferable to provide baffling in the transition zone to promote a temperature gradient. Provision of a refrigeration system selected to provide temperatures no higher than about 300 C to the carbon collection zone further promotes the temperature gradient. The temperature gradient is further promoted by having at least one radiator in the working zone.

If nitrogen is present in the treatment gas, it too can be separated by the separator by slightly modifying the separator through the addition of at least one nitrogen permeable membrane in the carbon collection zone and a nitrogen outlet for gaseous communication with the at least one nitrogen permeable membrane. The nitrogen permeable membrane operates a relatively low temperature, therefore the cooling system is further defined as a refrigeration system selected to provide temperatures no higher than about 60 C to the carbon collection zone.

It is preferably to have a carbon filter surrounds the at least one nitrogen permeable membrane to reduce the possibility of carbon particles plugging the membrane.

As some carbon dioxide may pass through the nitrogen permeable membrane, a gas return in communication with the nitrogen outlet and the working zone can be provided for returning gas to the working zone.

Other components which can be included to increase the efficiency of carbon collection include carbon collection structures, at least one of an electrostatic precipitator and a magnet, a sub-chamber (for higher pressure collection of diamond carbon) and a slipstream adjunct separator in gaseous communication with the chamber.

In a second embodiment. a method of producing solid carbon and gaseous oxygen from a treatment gas in a separator is provided. The method permits industrial scale treatment of carbon dioxide and/or carbon monoxide from, for example, but not limited to, flue gases. The method comprises the steps of:

(i) providing a pressurized treatment gas to a chamber, the chamber comprising a working zone, a transition zone and a carbon collection zone, the treatment gas being introduced into the working zone;

(ii) operating the separator by:
adjusting the gas pressure in the chamber to at least about 0.07 MPa to at most about 9.65 MPa;
heating the working zone to at least about 1000 C to at most about 2400 C;
maintaining the carbon collection zone to a temperature of at most about 800 C;
maintaining a thermal gradient of at least about 700 C between the working zone and the carbon collection zone; and
generating about 10 Amps to about 150 Amps in the working zone of the chamber,
thereby exposing the treatment gas to a thermal-dielectric-electric field in the chamber under conditions below supercritical;

(iii) extracting ionic oxygen through an oxygen permeable membrane housed in the working zone; and

(iv) collecting solid carbon in the carbon collection zone,

thereby producing solid carbon and gaseous oxygen from a treatment gas.

It is preferable that the working zone is heated to a temperature between about 1100 C and about 2200 C and the amperage is maintained between about 40 Amps and about 120 Amps, and more preferable that the working zone is heated to a temperature between about 1200 C and about 1900 C and the amperage is maintained between about 50 Amps and about 100 Amps.

It is preferable that the temperature in the carbon collection zone is maintained at no higher than about 300 C and more preferable that it is maintained at no higher than about 0 C to assist in carbon collection and to promote the temperature gradient.

For industrial applications, it is preferable that the chamber volume ranges from about 0.5 m³ to about 500 m³.

Different operating conditions promote production of different types of carbon. For the production of amorphous carbon, the operating pressure is maintained at about 0.158 MPa, for the production of graphite and nano-carbon, the operating pressure is maintained at about 0.241 MPa and for the production of diamond carbon, the operating pressure is maintained between about 0.414 MPa and about 0.517 MPa.

As the pressure is quite high for the production of diamond carbon, it is preferable, from a safety standpoint that amorphous carbon is collected and delivering it to a sub-chamber, wherein the operating pressure in the sub-chamber is maintained between about 0.414 MPa and about 0.517 Mpa.

Specific operating conditions include:
1. adjusting the gas pressure to at least about 0.07 MPa to at most about 0.17 MPa;
   heating the working zone to at least about 1400 C to at most about 1700 C;
   cooling the carbon collection zone to a temperature of at most about 300 C;
   maintaining a thermal gradient of at least about 1100 C between the working zone and the carbon collection zone; and
   generating about 55 Amps to about 59 Amps in the working zone of the chamber,
2. adjusting the gas pressure to at least about 0.07 MPa to at most about 0.17 MPa;
   heating the working zone to about 1400 C;
   cooling the carbon collection zone to a temperature of at most about 300 C;
   maintaining a thermal gradient of at least about 1100 C between the working zone and the carbon collection zone; and
   generating about 55 Amps to about 59 Amps in the working zone of the chamber, and
3. adjusting the gas pressure to about 0.17 MPa;
   heating the working zone to a temperature range of about 1500 C to about 1700 C;
   cooling the carbon collection zone to a temperature of at most about 300 C;
   maintaining a thermal gradient of at least about 1100 C between the working zone and the carbon collection zone; and
   generating about 55 Amps to about 59 Amps in the working zone of the chamber.

As noted above, nitrogen oxides can be separated into nitrogen and oxygen. This involves cooling the carbon collection zone to a temperature of at most about 60 C and extracting ionic nitrogen through a nitrogen permeable membrane housed in the carbon collection zone of the chamber.

Preferably, the apparatus for co-producing solid carbon and gaseous oxygen from a pressurized treatment gas can be used for the following method:

(i) introducing the pressurized treatment gas to the working zone of the chamber;

(ii) operating the apparatus by:
adjusting the gas pressure to at least about 0.07 MPa to at most about 9.65 MPa;
heating the working zone to at least about 1000 C to at most about 2400 C;
cooling the carbon collection zone to a temperature of at most about 300 C;
maintaining a thermal gradient of at least about 700 C between the working zone and the carbon collection zone; and
generating about 10 Amps to about 150 Amps in the working zone of the chamber,
thereby exposing the treatment gas to a thermal-dielectric-electro field in the chamber under conditions below supercritical;

(iii) extracting ionic oxygen through the oxygen permeable membrane; and

(iv) collecting solid carbon in the carbon collection zone,

thereby co-producing solid carbon and gaseous oxygen from a treatment gas.

Similarly, the apparatus for co-producing carbon, oxygen and nitrogen from a pressurized treatment gas can be used for the following method:

(i) introducing the pressurized treatment gas to the working zone of the chamber;

(ii) operating the apparatus by:
adjusting the gas pressure to at least about 0.07 MPa to at most about 9.65 MPa;
heating the working zone to at least about 1000 C to at most about 2400 C;
cooling the carbon collection zone to a temperature of at most about 60 C;
maintaining a thermal gradient of at least about 700 C between the working zone and the carbon collection zone; and
generating about 10 Amps to about 150 Amps in the working zone of the chamber,
thereby exposing the treatment gas to a thermal-dielectric-electro-dynamic field in the chamber under conditions below supercritical;

(iii) extracting ionic oxygen through the oxygen permeable membrane;

(iv) extracting ionic nitrogen through the nitrogen permeable membrane; and

(iv) collecting solid carbon in the carbon collection zone,

thereby co-producing solid carbon, gaseous oxygen and gaseous nitrogen from a treatment gas.

### FIGURES

FIG. 1 is a longitudinal median section through the separator of the present technology.

FIG. 2 is a longitudinal median section through the carbon collection zone of the separator of FIG. 1 showing structures for the collection of nano-carbon.

FIG. 3 is a longitudinal median section through the carbon collection zone of the separator of FIG. 1 showing structures for the collection of diamond carbon.

FIG. 4 is a longitudinal median section through the separator of an alternative embodiment for the collection of nitrogen.

FIG. 5 is a longitudinal median section through the separator of FIG. 1 showing the convection currents.

FIG. 6 is a light micrograph of carbon collected in the carbon collection zone.

FIG. 7 is a light micrograph of carbon collected in the carbon collection zone.

FIG. 8 is a scanning electron micrograph of carbon collected in the carbon collection zone.

FIG. 9 is a scanning electron micrograph of carbon collected from the wall of the carbon collection zone.

### DESCRIPTION

### (i) THEORETICAL

Through the use of dielectrophoresis and electrophoreses, under pressure and in the presence of heat, carbon dioxide and carbon monoxide can be separated into ionic carbon and ionic oxygen. A field, referred to as a thermo-dielectric-electric-dynamic (TDEED) field is created through the implementation of a heat source and an electrode. The dielectric component of the TDEED field causes the molecules to be held static in a working zone around the heat source. Further, the X.Y.Z planes are made uniform and stable in the molecule or atom or ion when the species is in the field. These two effects of the dielectric field allows for targeting of thermal energy waves from the heat source on the bonds of the molecules rather than incoherent bombardment of thermal energy waves over the exterior of the molecules.

Each species has a different charge or property which emerges and is utilized when in the TDEED field; CO is a polar molecule, while O═C═O is linear, and both can be predictably positioned in the TDEED field on this basis. Similarly, O═N═O is linear and NO is a polar molecule as oxygen is negatively charged. The properties exhibited by the molecules while in the TDEED field, balanced in concert with the elevated gas pressure hold the molecules in stable orientations allowing their bonds to be deteriorated more effectively, thereby releasing ionic carbon and oxygen. An electrophoretic component of the TDEED field then repels oxygen atoms because of their charge, pushing them away from the TDEED field, and the more positive carbon atoms remain attracted to the field lines. The nitrogen becomes a nonmagnetic diatomic gas, which is relatively inert if it is present.

The efficiency of the process is further enhanced through thermal isolation of the heat source. This is accomplished, in part, by an oxygen permeable membrane that both removes oxygen from the apparatus and strips the oxygen ions of some of their heat prior to their removal; this heat is recycled. A thermal gradient, which may be passive or powered, further enhances the efficiency of the system, in addition to promoting the collection of carbon and nitrogen gas in low energy or cooler areas of the apparatus where the nitrogen permeable membrane and the carbon collection structure are located. The combination of the TDEED field and the thermal gradient allows for the removal of carbon dioxide, carbon monoxide and nitrogen oxides from treated flue gases at a rate suitable for industrial applications. The products, solid carbon, gaseous oxygen and gaseous nitrogen can then be utilized rather than sequestering or burying carbon dioxide, as is the current trend.

### (ii) DEFINITIONS

Dielectric Structure:

Dielectric structures refer to any electrode structure that has the following property: The electrode elements can produce electric fields when they are connected with and energized with electrical signals provided by a DC (direct current) or AC (alternating current) power source. Such electric fields may be non-uniform electric fields, traveling-wave electric fields, or non-uniform traveling wave electric fields, or electric fields of any other configuration. These electric fields preferably can exert dielectrophoretic forces and traveling wave dielectrophoretic forces on the particles that are suspended or placed in the solutions that are in contact with the electrode elements. Such dielectrophoretic and/or traveling-wave dielectrophoretic forces can then direct or focus or move the particles onto certain specific locations. Non-limiting examples of the dielectric focusing structures include spiral electrode structures, circular electrode structures, squared spiral electrode structures, traveling wave dielectrophoresis structures, particle switch structures, quadropole electrode structures, and electro rotation structures, or any electrodynamic created “well” structures.

Element:

An inert electrical heat source capable of functioning in an oxidizing environment and generating up to 2400 C heat at its surface.

Oxygen Permeable Membrane:

A formable, shapeable ceramic oxide membrane that is oxygen selective and oxygen permeable. Alternatively, it can be a thermal insulating ion conductor device. An oxygen permeable membrane is capable of operating under oxidizing conditions and producing a pure stream of ionized, non-ionized or atomic oxygen. The preferred oxygen permeable membrane comprises Yttria stabilized Zirconia oxide or Perovskite.

Oxygen Outlet:

A refractory pipe or collection area which is a designated space where collection of oxygen to be removed can occur. As would be known to one skilled in the art, the outlet is preferably heat and oxygen refractory.

Nitrogen Permeable Membrane:

A formable, shapeable ceramic oxide membrane that is nitrogen selective and nitrogen permeable. Alternatively, it can be a thermal insulating ion conductor device. A nitrogen permeable membrane is capable of producing a pure stream of ionized, non-ionized or atomic nitrogen. The preferred operating temperature for the membrane is between about −40 C to about 50 C, more preferably about −30 C to about 10 C, and most preferably about −20 C to about 15 C.

Nitrogen Outlet:

A pipe or collection area which is a designated space where collection of nitrogen to be removed can occur.

Non-Uniform Paramagnetic Field:

Non-uniform paramagnetic field is defined as an irregular shaped paramagnetic field which may have varying thickness and intensity. The field functions to interact with carbon dioxide and carbon monoxide molecules, orienting and stabilizing them for a period of time.

Radiator.

Any heat and oxygen refractory material capable of storing thermal energy, and recirculating stored energy in a high temperature environment in order to conserve heat and maximize thermal efficiency. Included in the definition, are black body radiators.

Magnetic Device:

Electro magnets, which are positioned on cylindrical, cube, or irregular surfaces or corners of the separator and that function to attract carbon.

Ferro magnets which are positioned on cylindrical, cube, or irregular surfaces or corners of the separator and that function to attract carbon.

Magneto Hydrodynamic Forces:

The magnetic to kinetic behavioral forces in a pressurized gas which are consistently distributed over the total number of molecule or atoms in the gas, causing the reaction of the gas to be consistent and predictable in an applied paramagnetic or magnetic electro dynamic or electrostatic force.

Cp:

Heat carrying capacity of an atom or molecule, usually defined as J/mol/K CVD:

Chemical Vapor Deposition

Pressurized Fluid:

In the context of the present technology, pressurized fluid refers to the fluid like properties of a hot, pressurized gas.

Dielectrophoresis:

Dielectrophoresis is a phenomenon in which a force is exerted on a dielectric particle when it is subjected to a non-uniform electric field. The dielectrophoretic component of the TDEED field is the process that permits the molecules of carbon dioxide and carbon monoxide or nitrogen dioxide and nitrogen oxide (collectively referred to as NOx) to be polarized and transiently held in position.

Thermal Decomposition:

Thermal decomposition is defined as a chemical reaction in which a chemical substance breaks up into at least two chemical substances when heated. In the context of the present technology, thermal decomposition breaks the carbon-oxygen bonds of carbon dioxide and carbon monoxide and/or the nitrogen-oxygen bonds of NOx in the TDEED field.

Electrophoresis:

Electrophoresis is the separation of species on the basis of charge when subjected to an electric field. Electrophoresis occurs after the carbon-oxygen bonds are broken thereby producing ionic carbon and oxygen. The electrophoretic component of the TDEED field repels atomic oxygen because of its charge, whereas the carbon atom remains attracted and the nitrogen atom becomes neutral to the field lines.

Thermal Repulsion:

Thermal repulsion is the means by which species having a poor heat capacity are removed from the TDEED field. Thermal repulsion occurs to atomic carbon and nitrogen.

### (iii) APPARATUS

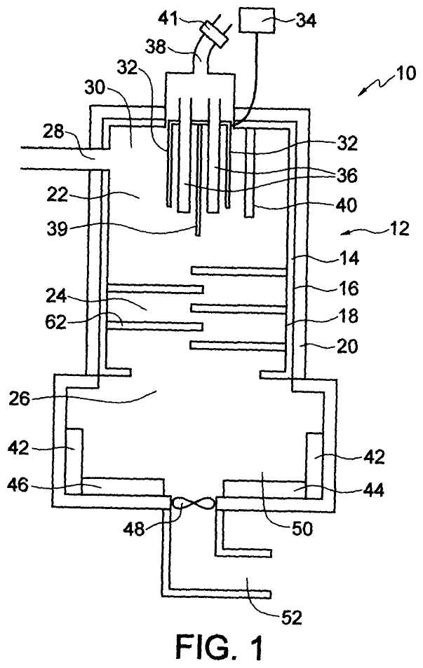

Referring to FIG. 1, a separator for oxygen and carbon, generally referred to as 10 is provided. The separator 10 has a chamber 12, which has a wall 14 having an outer surface 16 and an inner surface 18. A layer of insulation 20 is provided on the outer surface 16, to assist in maintaining the temperature in the chamber 12. The chamber 12 has a working zone 22, a transition zone 24 and a carbon collection zone 26. An inlet 28 for carbon dioxide is located in the vicinity of the top 30 of the chamber, to provide carbon dioxide into the working zone 22 of the chamber 12. At least one heating element 32, and preferably two or more, are located in the working zone 22 and are in electrical communication with a power source 34 when in use. Alternatively, the heating element 32 may be replaced with a heat source such as waste heat from nuclear energy or fusion reactions. At least one oxygen permeable membrane 36 is also located in the working zone 22 and is in gaseous communication with an oxygen outlet 38. A suction pump 41 is in gaseous communication with the oxygen outlet 38. The membranes, when formed into a plate, range from about 4.5×4.5 cm to about 4M×4M. The membranes, when formed into tubes, range in diameter and length from about 2.25 cm OD by 12 cm to about 360cm OD by 6200 cm. Heating elements 32 are preferably positioned around the plate in a spaced pattern or around the tube in a circular array.

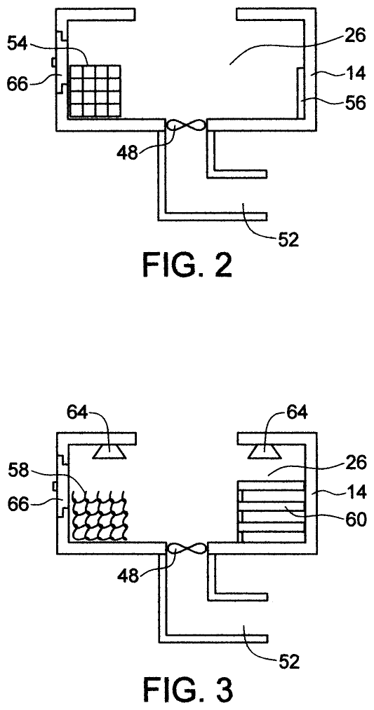

At least one dielectric structure 39 is present in the working zone 22. This dielectric structure may, for example, but not limited to, be a ferromagnetically or electrically charged electrode. Alternatively, the dielectric structure 39 and the heating element 32 are one component that provides both the dielectric and electrophoretic capability and the thermal energy. At least one radiator 40 is located in the working zone 22. A refrigeration system 42 is located in the carbon collection zone 26 or is external to the chamber 12, but provides coolant or cooling to the chamber 12. The refrigeration system 42 may, for example be, but is not limited to a water jacket, a dry ice bed, or a standard refrigeration system. Depending upon the type of carbon to be collected, different collection systems and collection structures are located in the carbon collection zone 26. For amorphous and fuel carbon collection, a magnet 44 and an electrostatic precipitator 46 are located in the carbon collection zone 26. A rotary valve 48 is located in the wall 14 in the vicinity of the bottom 50 of the chamber 12, for removal of the carbon. The rotary valve 48 is in communication with a carbon collector 52. As shown in FIG. 2, for graphite and carbon nano-wire collection, a stainless steel wire cage 54 or a rough surface area 56 that is porous is located in the carbon collection zone 26. As shown in FIG. 3, for diamond collection a wire cage 58 of very tight winding or/and shelves 60 are located in the carbon collection zone 26. As shown in FIG. 1, the transition zone 24 has baffling 62 that functions to insulate the carbon collection zone 26 from the working zone 22. As shown in FIG. 3, one or more powder dispersal devices 64 are optionally located in the carbon collection zone 26 to assist in introducing elements into the diamond carbon. Also shown in FIG. 3 (and FIG. 2) is an access port 66 for removing batches of carbon products.

In order to function efficiently means for assessing the rate of oxygen production are needed. One or more of a mass flow meter, pressure sensor or weigh scale can be employed.

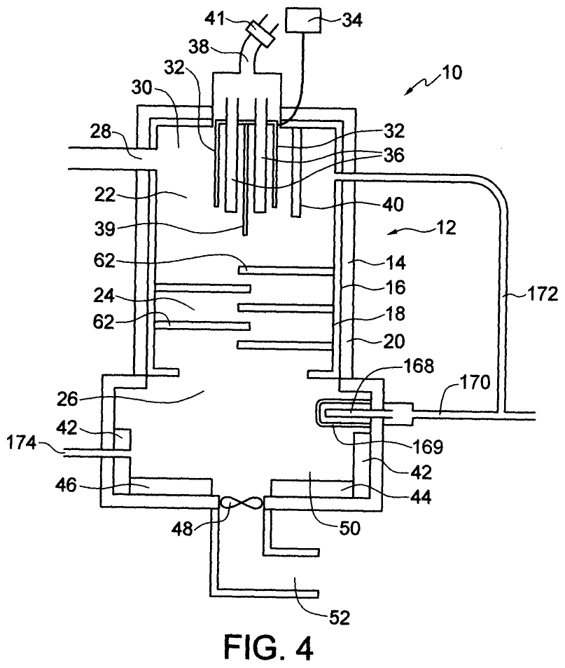

As shown in FIG. 4, in an alternative embodiment, nitrogen is separated from oxygen, in addition to the separation of carbon from oxygen. This requires at least one nitrogen permeable membrane 168 located in the carbon collection zone 26 and a nitrogen outlet 170. The nitrogen permeable membrane 168 preferably is protected from any carbon with carbon filters 169 that surround the nitrogen permeable membrane 168. A gas return 172 is in gaseous communication with the chamber 12 in the working zone 22 to permit any oxygen that traveled with the nitrogen to enter into the working chamber 12 for removal through the oxygen permeable membrane 36.

As shown in FIG. 4, but applicable to the embodiment of FIG. 1, is a gas inlet 174. The gas inlet provides pressurized gas, which is preferably carbon dioxide, to the carbon collection zone 26.

The chamber 12 is contemplated to range in size from a micro-chamber, to a mid-sized chamber, being in the range of about 0.5-4.0 m³ to a large industrial scale chamber, being in the range of about 5-500 m³.

### (iv) OPERATING CONDITIONS

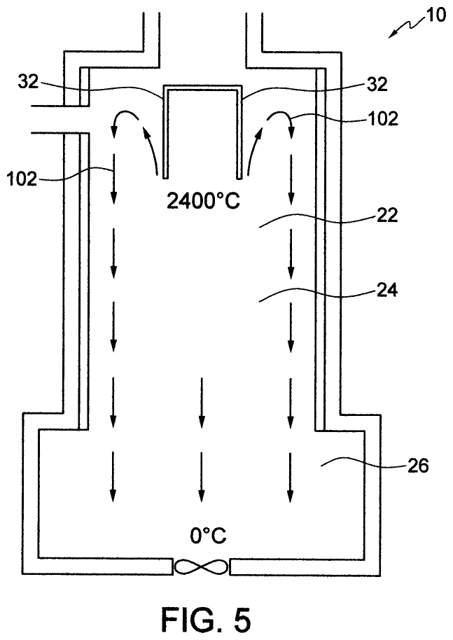

The operating temperature in the working zone 22 for carbon dioxide or nitrogen dioxide is preferably between about 1000 C to about 2400 C, more preferably between about 1100 C to about 2200 C and most preferably between about 1200 C and about 1900 C. In large chambers 12, multiple working zones 22 may be present. As shown in FIG. 5, there is a temperature gradient between the working zone 22 and the carbon collection zone 26. The temperature at the oxygen permeable membrane 38 is preferably about 800 C to about 1600 C, more preferably about 1000 C to about 1500 C and most preferably about 1100 C to about 1300 C.

The temperature in the carbon collection zone 26 is preferably no higher than about 800 C, more preferably no higher than about 300 C, and most preferably no higher than about 0 C. While no minimum temperature is contemplated, the approximate freezing point of carbon dioxide (−64 C) could be considered to be the lowest economical temperature. Nonetheless, lower temperatures could also be used. The temperature gradient is controlled by the temperature in the working zone 22, the temperature in the carbon collection zone 26, the physical barrier insulation 20 and baffling 62 (as shown in FIG. 1). The chamber 12 is pressurized to an operating pressure that is preferably between at least about 0.1 MPa to at most about 9.5 MPa. This can be effected by a pressure maintainer that is in communication with the chamber—it may be controlled upstream from the separator as a function of pressurizing the treatment gas, or alternatively, may be controlled by a pressure maintainer associated with the chamber and taking the form of, for example, but not limited to, a pressure gauge and pump. The amperages for dielectrophoresis and electrophoresis range from about 10 Amps to about 150 Amps, preferably about 40 Amps to about 120 Amps and most preferably about 50 Amps to 100 Amps.

### (v) METHOD

Dried carbon dioxide, and/or carbon monoxide and/or NOx (treatment gas), containing up to about 0.25 or 0.50% moisture is fed into the chamber 12 through the inlet 28 at a feed rate ranging from about 0.5 cubic M/minute to about 20 cubic M/minute per cubic meter of chamber 12. The preferred feed rate is about 5 cubic M/minute to about 15 cubic M/min per cubic meter of chamber 12 and the most preferred feed rate is 10-15 cubic M/min per cubic meter of chamber 12, preferably in a series or modular sequence of reactors. The treatment gas is preferably pressurized to 2.07 MPa to 13.8 MPa for delivery to the chamber 12. As noted above, once inside the chamber 12, the treatment gas is maintained and/or adjusted to an operating pressure that is preferably between at least about 0.103 MPa to at most about 9.65 MPa (1400 psi). In other words, at pressures below the critical pressure for carbon dioxide. The dielectric structure is operated at an amperage of about 10 to about 150 Amps. As shown in FIG. 5, in addition to the temperature gradient, a convection current 102 is manipulated and controlled in order to maximize the removal of oxygen, while transporting carbon and impurities, if present, to deposit in cooler areas. Nitrogen gas will similarly be transported by the convective current 102 from the working zone 22 to the carbon collection zone 26. The convection current 102 is generally vertically oriented, extending upward from the heating element 32, and then cascading downward in a fountain-like formation. Oxygen removal rates are about 2-3 cc of oxygen per cm2 per second to 50 cc of oxygen per cm2. The feed rate of treatment gas is governed by the permitivitty of the oxygen permeable membrane 32 and the pressure differential between the chamber 12 and the oxygen outlet 38. Under ideal operating conditions, for every mole of carbon dioxide/nitrogen dioxide injected per minute, two moles of atomic oxygen are removed per minute, for example.

### (vi) EXAMPLES

### Example 1

Preliminary Study of Oxygen Production from Carbon Dioxide

A steel box chamber was used to apply different conditions to Coleman CO₂ gas in small amounts; 700 cc working chamber and 500 cc exhaust chamber. A 150 watt MoSi₂ element was positioned dose to an Yttrium stabilized oxygen permeable ceramic oxide membrane. Prior to studying carbon deposition and oxygen evolution, an oxygen screening test was conducted. This was conducted during the warm up phase of 35 minutes to measure oxygen on either side of the oxygen permeable membrane. The pressure range was about 0.103-0.17 MPa, and the amperage range was about 30 to about 50 amps. Numbered bags contained samples taken from the input side of the oxygen permeable membrane (the carbon dioxide side) and lettered bags contained samples taken from the output side of the oxygen permeable membrane (oxygen evolution side). The following X series plot shows an exponential decay: 98% of the variability in the data is characterized by a smooth exponential decay. Significantly, the percentage of oxygen on the oxygen evolution side is much higher than it is on the carbon dioxide side, indicating that oxygen was being evolved by the system.

TABLE 1
X series plot

| Time | Amps | Bag # | O2 % | Bag # | O2 % |
|---|---|---|---|---|---|
| 0 | 0 | X-1 | 6 | X-A | 43 |
| 5 | 33.3 | | | | |
| 10 | 51 | X-2 | 7 | X-B | 33 |
| 15 | 51.7 | X-3 | 6 | X-C | 25 |
| 20 | 51.3 | X-4 | 7 | X-D | 18 |
| 5 | 51.8 | X-5 | 8 | X-E | 16 |
| 30 | 51.3 | | | | |
| 35 | 51.1 | X-6 | 9 | X-F | |

Note that argon interfered with a clear determination of when oxygen began being produced in the system for bag A. However it shows that the argon did decay over the 30 minute time period, so some of the oxygen reported in Bag B was likely oxygen produced from the method in an indeterminable amount, but likely higher in proportion than in bags 1,2 and 3 as shown in Table 3.

### Example 2

Production of Oxygen from Carbon Dioxide

A steel box chamber was used to apply different conditions to Coleman CO₂ gas in small amounts; 700 cc working chamber and 500 cc exhaust chamber. Pressures in the chamber studied were 0.069 MPa, 0.103 MPa, and 0.17 MPa, at 1400 C. The amperage was about 45 to about 59 amps. Target temperatures of 1400 C, 1500 C, 1600 C, and 1700 C were applied; the latter three were performed at 0.17 MPa. A 150 watt MoSi₂ element was positioned close to an Yttrium stabilized oxygen permeable ceramic oxide membrane. Gas samples were taken at the beginning, middle and end of a 1.5 hour operation cycle. The exhaust from the chamber through the membrane was also sampled for oxygen at 30, 50, 70 and 90 minutes in each run. All exhaust was placed in a cumulative sample bag except the 30 minute sample which could then be separately analyzed across all runs. The temperature at the carbon collection zone was about 800 C.

A standard regime of sampling was developed based on initial gas test results. For example it was found in an early run that at 30 minutes into the run, when the amperage had reached a maximum value for 15 minutes, there was oxygen evolved in the exhaust. This was consistently verified at the 30 minute point by taking exhaust samples each run and recorded for comparison. Table 2 shows the procedure used.

TABLE 2
Standardized test protocol

Purge Exhaust with Argon
Purge main chamber with Coleman grade CO₂ and pressurize
Take control sample from main chamber (Bag 1)
Start 90 minute run, recording amps, target readout, both thermocouple
readings Q 5 min.
At 30 minutes, take chamber sample (Bag 2) and exhaust sample (Bag A)
At 50, 70 and 90 minutes take supplemental exhaust samples and combine
in one bag (Bag B)
At 90 minutes, take final chamber sample (Bag 3)

Table 3 shows the results using a temperature range of 1000-1600 C, pressure range of 0.103 to 0.17 MPa, and amperage range of 55-59 amps for 60 minute run times. The table is divided into two parts. Carbon dioxide and oxygen are in ppm×1000.

TABLE 3
Part 1

| | | | | | | | | | |
|---|---|---|---|---|---|---|---|---|---|
| MPa | .069 | .069 | .069 | .103 | .103 | .103 | .17 | .17 | .17 |
| Temp | 1400 C. | 1400 C. | 1400 C. | 1400 C. | 1400 C. | 1400 C. | 1400 C. | 1400 C. | 1400 C. |
| Bag 1 | | | | | | | | | |
| CO2 ppm | 820 | 800 | 800 | 900 | 810 | 830 | 850 | 930 | 850 |
| CO ppm | 1 | 1 | 1 | 2 | 2 | 1 | 1 | 2 | 1 |
| O2 ppm | 72 | 60 | 60 | 39 | 58 | 60 | 50 | 35 | 54 |
| Bag 2 | | | | | | | | | |
| CO2 ppm | 810 | 770 | 790 | 930 | 790 | 790 | 810 | 880 | 820 |
| CO ppm | 58 | 74 | 5 | 13 | 17 | 100 | 24 | 20 | 11 |
| O2 ppm | 71 | 70 | 60 | 32 | 61 | 67 | 58 | 34 | 55 |
| Bag 3 | | | | | | | | | |
| CO2 ppm | 890 | 790 | 780 | 920 | 800 | 830 | 840 | 770 | 830 |
| CO ppm | 460 | 13 | 220 | 360 | 100 | 57 | 250 | 33 | 14 |
| O2 ppm | 41 | 60 | 60 | 34 | 59 | 56 | 51 | 64 | 55 |
| Bag A | | | | | | | | | |
| CO2 ppm | 300 | 290 | 430 | 470 | 370 | 410 | 490 | 570 | 390 |
| CO ppm | 5 | 6 | 8 | 7 | 3 | 11 | 5 | 9 | 2 |
| O2 ppm | 640 | 510 | 380 | 505 | 471 | 438 | 238 | 428 | 498 |
| Bag B | | | | | | | | | |
| CO2 ppm | 780 | 690 | 680 | 800 | 840 | 750 | 770 | 790 | 810 |
| CO ppm | 64 | 50 | 27 | 73 | 35 | 81 | 87 | 19 | 7 |
| O2 ppm | 151 | 160 | 170 | 1380 | 128 | 125 | 118 | 118 | 136 |

Part 2

| | | | | | | | | | |
|---|---|---|---|---|---|---|---|---|---|
| MPa | .17 | .17 | .17 | .17 | .17 | .17 | .17 | .17 | .17 |
| Temp | 1500 C. | 1500 C. | 1500 C. | 1600 C. | 1600 C. | 1600 C. | 1700 C. | 1700 C. | 1700 C. |
| Bag 1 | | | | | | | | | |
| CO2 ppm | 820 | 820 | 870 | 840 | 880 | 840 | 860 | 920 | 910 |
| CO ppm | 1 | 1 | 1 | 1 | 1 | 1 | 1 | 1 | 1 |
| O2 ppm | 54 | 52 | 41 | 49 | 47 | 46 | 43 | 46 | 46 |
| Bag 2 | | | | | | | | | |
| CO2 ppm | 850 | 800 | 860 | 810 | 670 | 840 | 870 | 900 | 980 |
| CO ppm | 4 | 4 | 2 | 1 | 1 | 1 | 1 | 1 | 1 |
| O2 ppm | 50 | 56 | 43 | 59 | 83 | 56 | 51 | 48 | 31 |
| Bag 3 | | | | | | | | | |
| CO2 ppm | 820 | 820 | 870 | 820 | 870 | 860 | 890 | 920 | 1000 |
| CO ppm | 13 | 17 | 13 | 14 | 5 | 8 | 8 | 20 | 2 |
| O2 ppm | 48 | 51 | 40 | 52 | 50 | 45 | 45 | 45 | 28 |
| Bag A | | | | | | | | | |
| CO2 ppm | 510 | 500 | 610 | 540 | 460 | 820 | 540 | 570 | 610 |
| CO ppm | 1 | 1 | 1 | 1 | 1 | 1 | 1 | 1 | 1 |
| O2 ppm | 415 | 378 | 307 | 383 | 417 | 59 | 367 | 398 | 438 |
| Bag B | | | | | | | | | |
| CO2 ppm | 780 | 760 | 890 | 790 | 840 | 810 | 910 | 860 | 910 |
| CO ppm | 5 | 6 | 4 | 2 | 2 | 2 | 2 | 2 | 1 |
| O2 ppm | 112 | 110 | 72 | 99 | 117 | 54 | 93 | 104 | 116 |

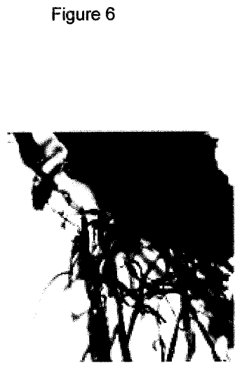

The important findings were that carbon dioxide levels were lower in the exhaust than in the chamber, oxygen was produced, particulate carbon was produced (see FIGS. 6-9) and carbon monoxide levels in the chamber decreased as the temperature and pressure increased. The latter supports the theory of thermal dissociation.

Table 4 below shows oxygen in ppm×1000, using the protocol as described above. The temperature range was 1000-1600 C, the pressure range was 0.103 to 0.17 MPa, and the amperage range was 55-59 amps for 60 minute run times.

| | | | | | | | | | |
|---|---|---|---|---|---|---|---|---|---|
| MPa | .069 | .069 | .069 | .103 | .103 | .103 | .17 | .17 | .17 |
| Temp (C.) | 1400 | 1400 | 1400 | 1400 | 1400 | 1400 | 1400 | 1400 | 1400 |
| 1 | 72 | 60 | 60 | 39 | 58 | 60 | 50 | 35 | 54 |
| 2 | 71 | 70 | 60 | 32 | 61 | 67 | 58 | 34 | 55 |
| 3 | 41 | 60 | 60 | 34 | 59 | 56 | 51 | 64 | 55 |
| A | 640 | 510 | 360 | 505 | 471 | 438 | 238 | 428 | 498 |
| B | 151 | 160 | 170 | 138 | 128 | 125 | 118 | 118 | 136 |
| MPa | .17 | .17 | .17 | .17 | .17 | .17 | .17 | .17 | .17 |
| Temp (C.) | 1500 | 1500 | 1500 | 1600 | 1600 | 1600 | 1700 | 1700 | 1700 |
| 1 | 54 | 52 | 41 | 49 | 47 | 46 | 43 | 46 | 46 |
| 2 | 50 | 56 | 43 | 59 | 83 | 56 | 51 | 48 | 31 |
| 3 | 48 | 51 | 40 | 52 | 50 | 45 | 45 | 45 | 28 |
| A | 415 | 378 | 307 | 383 | 417 | 590 | 367 | 398 | 438 |
| B | 112 | 110 | 72 | 99 | 117 | 54 | 93 | 104 | 116 |

These results indicate a breakdown of CO2 into oxygen, carbon monoxide and carbon in the early testing platform. There was solid carbon each time the chamber was inspected. The results indicate changes in the chamber (samples labeled Bags 1, 2, 3); and in the exhaust (samples labeled Bag A and B). The most important finding was the evidence of CO2 breaking down into carbon, CO and oxygen. The oxygen traveled across the membrane and carbon solids were found in the chamber.

### Example 3

Production of Carbon from Carbon Dioxide

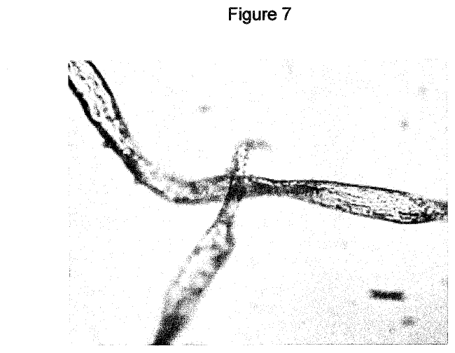

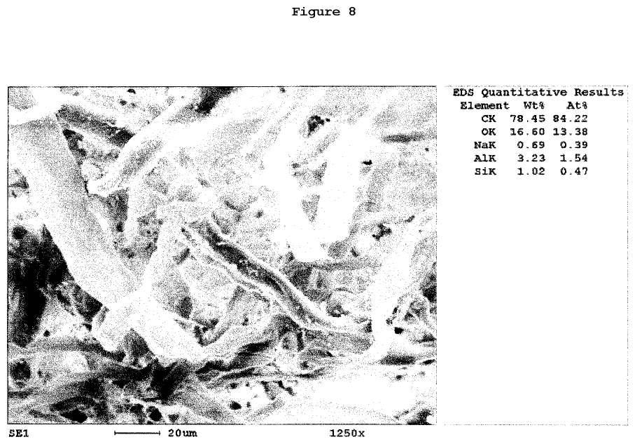

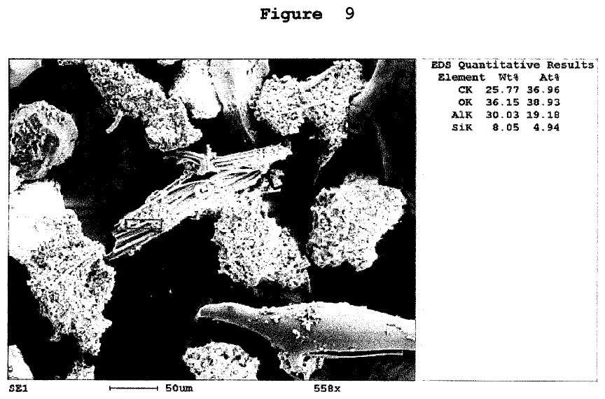

In addition to measuring carbon dioxide, carbon monoxide and oxygen levels, collection of carbon in the chamber was assessed, as noted above. Samples of carbon deposits were viewed using scanning electron microscopy and light microscopy. FIGS. 6 and 7 shows light micrographs of carbon deposits from the carbon collection zone. FIG. 8 is a scanning electron micrograph taken of carbon from the carbon collection zone. FIG. 9 is a scanning electron micrograph taken of carbon from the wall of the carbon collection zone. The results from Examples 2 and 3 indicate that there is co-production of solid carbon and gaseous oxygen using the methods and apparatus of the present technology.

### Example 4

Continuous Production of Oxygen, Soot and Amorphous Carbon

Soot and amorphous carbon will be formed from carbon dioxide and carbon monoxide by subjecting the treatment gas in the chamber to pressures of between about 0.103 MPa to about 0.207 MPa, preferably between about 0.138 MPa to about 0.17 MPa and most preferably about 0.158 MPa, using the temperature ranges, amperages, treatment gas feed rates and oxygen removal rates described in Section (v). The rotary valve 48 located in the wall 14 in the vicinity of the bottom 50 of the chamber 12, will be employed for removal of the carbon. As the rotary valve 48 is in communication with a carbon collector 52, the carbon can be continuously produced.

### Example 6

Bulk Production of Oxygen, Graphite and Nano-Carbon

Graphite and nano-carbon will be produced from carbon dioxide and carbon monoxide by subjecting the treatment gas in the chamber to pressures of between about 0.103 MPa to about 0.345 MPa, preferably between about 0.138 MPa to about 0.31 MPa and most preferably about 0.241 MPa, using the temperature ranges, amperages, treatment gas feed rates and oxygen removal rates described in Section (v). Collection will be bulk, using the stainless steel wire cage 54, rough surface area 56 that is porous or shelves 60 located in the carbon collection zone 26. Excess soot and amorphous carbon will be removed as described above, using the rotary valve 48 or scraping devices.

### Example 6

Bulk Production of Oxygen and Diamond Carbon

Diamond carbon and colored diamond carbon will be produced from carbon dioxide and carbon monoxide by subjecting the treatment gas in the chamber to pressures of between about 0.31 MPa to about 9.65 MPa, preferably between about 0.345 MPa to about 0.689 MPa and most preferably about 0.414 MPa to about 0.517 MPa, using the temperature ranges, amperages, treatment gas feed rates and oxygen removal rates described in Section (v). Collection will be bulk, using the wire cage 58 of very tight winding or/and shelves 60 located in the carbon collection zone 26. Excess soot and amorphous carbon will be removed as described above, using the rotary valve 48 or scraping devices. The diamond carbon will self-seed and alternatively, will be seeded using seed diamonds. Colour will optionally be added using, for example, but not limited to, chromium iron, titanium, to produce, colours, for example, but not limited to corundum blue, yellow, pink, purple, orange, or green. The optional powder dispersal device will assist in the impregnation of the carbon with these elements.

Alternatively, the carbon will be collected as for the continuous production of carbon, and delivered, using the rotary valve, into a sub-chamber. The sub-chamber will be pressurized to pressures of between about 0.31 MPa to about 9.65 MPa, preferably between about 0.345 MPa to about 0.689 MPa and most preferably about 0.414 MPa to about 0.517 MPa. Collection will be bulk, using the wire cage 58 of very tight winding or/and shelves 60 located in the sub-chamber. The diamond carbon will self-seed and alternatively, will be seeded using seed diamonds. Colour will optionally be added using, for example, but not limited to, chromium iron, titanium, to produce, colours, for example, but not limited to corundum blue, yellow, pink, purple, orange, or green. The optional powder dispersal device will be located in the sub-chamber and will assist in the impregnation of the carbon with these elements.

### Example 7

Production of Nitrogen, Oxygen and Carbon

Nitrogen, oxygen and carbon will be produced from nitrogen oxides, carbon dioxide and carbon monoxide. Additional electrodes, as needed, will be placed in the working zone 22 to ensure that the temperature can be maintained. Similarly, additional oxygen permeable membranes will be placed in the working zone 22, to accommodate oxygen liberated from NOx. Liberated nitrogen will flow to the carbon collection zone 26 where it will be captured using the nitrogen permeable membranes 168. The temperature at the nitrogen permeable membrane will be no more than about 60 C, more preferably between about 0 C and about 50 C. Additional cooling may be provided at the membrane as needed, using the refrigeration system 42.

### Example 8

Adjunct Carbon Separator

A carbon dioxide and carbon monoxide gas slipstream adjunct separator is contemplated for use with the apparatus as described above. The adjunct separator provides an enhanced cool area, which may be water jacketed or forcibly cooled and allows for mechanical or thermally induced circulation of reacted carbon particles suspended in the gases. It is located proximate to the carbon collection zone 26 and is in communication with the carbon collection zone 26. The adjunct separator provides a zone where different carbons can be collected on different sized mesh screen or wire devices. A flow through returns the gases back into the working zone 22, preferably close to the gas return 172.

An internal fan system may provide the gas flow through the slipstream, both a pressure fan and a suction fan may be employed. The size of the flow are will range from 30 cm diameter to 240 cm in diameter and be of any practical length for operation with the main reactor. Carbon dioxide and carbon monoxide fed into the system may also create the slipstream flow.

The foregoing is a description of the present technology. As would be known to one skilled in the art, variations are contemplated that do not alter the scope of the technology. For example, the apparatus, rather than having both one or more magnets and an electrostatic device for the collection of carbon, may only have an electrostatic device, a single chamber or multiple chambers in series or parallel may be employed, the convective currents need not be uniform, the thermal gradient can be controlled by varying the thickness of the insulation on the chamber wall rather than using baffling within the chamber or in addition to baffling, water jackets or other external cooling devices may be used to control the temperature gradient and to cool the carbon collection zone, additional heating elements may be employed at the oxygen permeable membrane, additional dielectric structures can be employed in addition to one component that can provide both the dielectric and electrophoretic capability and the thermal energy and various sizes of chambers can be employed, the constraint being that the thermal gradient can be established. The operating conditions can vary in terms of temperature and pressure, but are maintained below supercritical pressure conditions. The treatment gases can be any one of carbon dioxide, carbon monoxide, nitrogen oxides, or combinations thereof.

We claim:

1-30. (canceled)

31. An apparatus for co-production of solid carbon and gaseous oxygen from a treatment gas, the apparatus comprising:
(i) a chamber having a working zone, a transition zone, and a carbon collection zone, wherein at least one dielectric structure, at least one oxygen permeable membrane and at least one heat source are located in the working zone and wherein at least one carbon collection system is located in the carbon collection zone;
(ii) a treatment gas inlet located in the vicinity of the top of the chamber to provide treatment gas to the working zone;
(iii) a pressure maintainer in communication with the chamber;
(iv) an oxygen outlet in gaseous communication with the oxygen permeable membrane;
(v) an optional cooling source located in the vicinity of the bottom of the chamber to provide cooling to the carbon collection zone; and
(vi) a valve or access port located in the vicinity of the bottom of the chamber for removal of solid carbon from the carbon collection zone.

32. The apparatus of claim 31, wherein the at least one dielectric structure and the at least one heat source are integrated into an at least one component that provides dielectric and electrophoretic capability and thermal energy.

33. The apparatus of claim 32 wherein the at least one component is an electrical heating element, selected to provide temperatures ranging from about 1000 C to about 2400 C and amperages ranging from about 10 amps to about 150 amps.

34. The apparatus of claim 33 further comprising baffling in the transition zone.

35. The apparatus of claim 34 wherein the cooling system is a refrigeration system selected to provide temperatures no higher than about 300 C to the carbon collection zone.

36. The apparatus of claim 35, further comprising an at least one radiator in the working zone.

37. The apparatus of claim 35, further comprising an at least one nitrogen permeable membrane in the carbon collection zone and a nitrogen outlet for gaseous communication with the at least one nitrogen permeable membrane such that the apparatus is additionally for co-production of nitrogen and wherein the cooling system is further defined as a refrigeration system selected to provide temperatures no higher than about 60 C to the carbon collection zone.

38. The apparatus of claim 37 further comprising a carbon filter surrounding the at least one nitrogen permeable membrane.

39. The apparatus of claim 38 further comprising a gas return in communication with the nitrogen outlet and the working zone for returning gas to the working zone.

40. The apparatus of claim 36 wherein carbon collection structures are provided in the carbon collection zone.

41. The apparatus of claim 36 further wherein the carbon collection system comprises at least one of an electrostatic precipitator and a magnet.

42. The apparatus of claim 36 further comprising a slipstream adjunct separator in gaseous communication with the chamber.

43. A method of producing solid carbon and gaseous oxygen from a treatment gas in a separator, comprising the steps of:
(i) providing a pressurized treatment gas to a chamber, the chamber comprising a working zone, a transition zone and a carbon collection zone, the treatment gas being introduced into the working zone;
(ii) operating the separator by:
adjusting the gas pressure in the chamber to at least about 0.07 MPa to at most about 9.65 MPa;
heating the working zone to at least about 1000 C to at most about 2400 C;
maintaining the carbon collection zone to a temperature of at most about 800 C;
maintaining a thermal gradient of at least about 700 C between the working zone and the carbon collection zone; and
generating about 10 Amps to about 150 Amps in the working zone of the chamber, thereby exposing the treatment gas to a thermal-dielectric-electric field in the chamber under conditions below supercritical;
(iii) extracting ionic oxygen through an oxygen permeable membrane housed in the working zone; and
(iv) collecting solid carbon in the carbon collection zone,
thereby producing solid carbon and gaseous oxygen from a treatment gas.

44. The method of claim 43 wherein the working zone is heated to a temperature between about 1100 C and about 2200 C and the amperage is maintained between about 40 Amps and about 120 Amps.

45. The method of claim 44 wherein the temperature in the carbon collection zone is maintained at no higher than about 300 C.

46. The method of claim 45, wherein the operating pressure is maintained at about 0.158 MPa for the production of amorphous carbon, 0.241 MPa for the production of graphite and nano-carbon and between about 0.414 MPa and about 0.517 MPa for the production of diamond carbon.

47. The method of claim 43 wherein operating the separator is further defined as:
adjusting the gas pressure to at least about 0.07 MPa to at most about 0.17 MPa;
heating the working zone to at least about 1400 C to at most about 1700 C;
cooling the carbon collection zone to a temperature of at most about 300 C;
maintaining a thermal gradient of at least about 1100 C between the working zone and the carbon collection zone; and
generating about 55 Amps to about 59 Amps in the working zone of the chamber.

48. The method of claim 47 wherein operating the separator is further defined as:
adjusting the gas pressure to at least about 0.07 MPa to at most about 0.17 MPa;
heating the working zone to about 1400 C;
cooling the carbon collection zone to a temperature of at most about 300 C;
maintaining a thermal gradient of at least about 1100 C between the working zone and the carbon collection zone; and
generating about 55 Amps to about 59 Amps in the working zone of the chamber.

49. The method of claim 48 further comprising cooling the carbon collection zone to a temperature of at most about 60 C and extracting ionic nitrogen through a nitrogen permeable membrane housed in the carbon collection zone of the chamber.

50. A method of co-producing solid carbon and gaseous oxygen from a pressurized treatment gas using the apparatus of claim 36 comprising the steps of:
(i) introducing the pressurized treatment gas to the working zone of the chamber;
(ii) operating the apparatus by:
adjusting the gas pressure to at least about 0.07 MPa to at most about 9.65 MPa;
heating the working zone to at least about 1000 C to at most about 2400 C;
cooling the carbon collection zone to a temperature of at most about 300 C;
maintaining a thermal gradient of at least about 700 C between the working zone and the carbon collection zone; and
generating about 10 Amps to about 150 Amps in the working zone of the chamber, thereby exposing the treatment gas to a thermal-dielectric-electro field in the chamber under conditions below supercritical;
(iii) extracting ionic oxygen through the oxygen permeable membrane; and
(iv) collecting solid carbon in the carbon collection zone,
thereby co-producing solid carbon and gaseous oxygen from a treatment gas.
